(19) United States
(12) Patent Application Publication
(10) Pub. No.: US 2008/0140281 A1
(43) Pub. Date: Jun. 12, 2008

(54) AUTOMATIC SYSTEM AND METHOD FOR VEHICLE DIAGNOSTIC DATA RETRIEVAL USING MULTIPLE DATA SOURCES

(75) Inventors: Dan O. MORRIS, Troy, MI (US); Colin J. FIELDING, South Lyon, MI (US); Thomas L. KOTENKO, Macomb Twp., MI (US)

Correspondence Address: MCDERMOTT WILL & EMERY LLP, 600 13TH STREET, N.W., WASHINGTON, DC, 20005-3096, US

(73) Assignee: IDSC HOLDINGS, LLC, Kenosha, WI (US)

(21) Appl. No.: 11/924,520

(22) Filed: Oct. 25, 2007

Related U.S. Application Data
(60) Provisional application No. 60/862,962, filed on Oct. 25, 2006.

(51) Int. Cl. G01M 17/00; G06F 17/30

(52) U.S. Cl. 701/33

(57) ABSTRACT

An exemplary scan tool according to this disclosure receives diagnostic information, such as DTCs, from an on-board diagnostic system. The scan tool automatically generates a search query using the received diagnostic information, and initiates data search on multiple pre-identified data sources.

### RELATED APPLICATION

This application claims the benefit of priority from U.S. provisional patent application Ser. No. 60/862,962, filed Oct. 25, 2006 and entitled “AUTOMATIC SYSTEM AND METHOD FOR VEHICLE DIAGNOSTIC DATA RETRIEVAL USING MULTIPLE DATA SOURCES,” the disclosure of which is incorporated herein in its entirety.

### FIELD OF THE DISCLOSURE

The present disclosure relates to automatic method and system for retrieving information related to vehicle diagnostic data using multiple data sources on a data transmission network, and more specifically, to automatic compilation and generation of search queries based on diagnostic information, such as diagnostic trouble codes, downloaded from an on-board diagnostic computer of a vehicle, submission of the generated search queries to pre-selected search engines using a data transmission network, such as the internet, for retrieving information from multiple data sources on the data transmission network.

### BACKGROUND OF THE DISCLOSURE

The automotive diagnostic industry needs to access information related to diagnostic trouble codes (DTC) obtained by scanners. However, not all garages can afford to purchase or maintain a database storing all information or suggested fixes related to different DTC for different vehicles. Therefore, there is a need for an inexpensive data retrieval system utilizing basic network resources to retrieve diagnostic data. There is another need for an automated method and system for obtaining information related different DTCs using multiple data sources.

### SUMMARY OF THE DISCLOSURE

This invention provides a scan tool access to information on the World Wide Web relevant to DTCs, and allows the scan tool to retrieve needed information at low cost and less storage space than an integrated database.

An exemplary scan tool addresses the above-noted needs as well as other needs. The exemplary scan tool is external to a vehicle and receives diagnostic information, such as DTCs, from an on-board diagnostic system. The scan tool automatically generates a search query using the received diagnostic information, and initiates data search on multiple data sources using one or more search engines. In one aspect, the scan tool generates the search query by adding additional selected information, such as based on the content of the diagnostic information or the vehicle under test.

An exemplary scan tool includes a data processor, a data port for receiving diagnostic information from an on-board computer, and a data storage device storing instructions that, upon execution by the data processor, control the scan tool to generate a search query based on the received diagnostic information, initiate a data search for information from multiple data sources, and provide the information found by the data search.

Additional aspects and advantages of the present disclosure will become readily apparent to those skilled in this art from the following detailed description, wherein only exemplary embodiments of the present disclosure is shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1 is a block diagram showing system architecture of an on-board diagnostic system to which an exemplary scan tool may connect.

FIG. 2 shows a block diagram of an exemplary scan tool.

FIG. 3 is a flow chart illustrating the operation of an exemplary scan tool according to this disclosure.

### DETAILED DESCRIPTION OF THE DISCLOSURE

In the following description, for the purposes of explanation, numerous specific details are set forth in order to provide a thorough understanding of the present disclosure. It will be apparent, however, to one skilled in the art that the present disclosure may be practiced without these specific details. In other instances, well-known structures and devices are shown in block diagram form in order to avoid unnecessarily obscuring the present disclosure.

### System Architecture

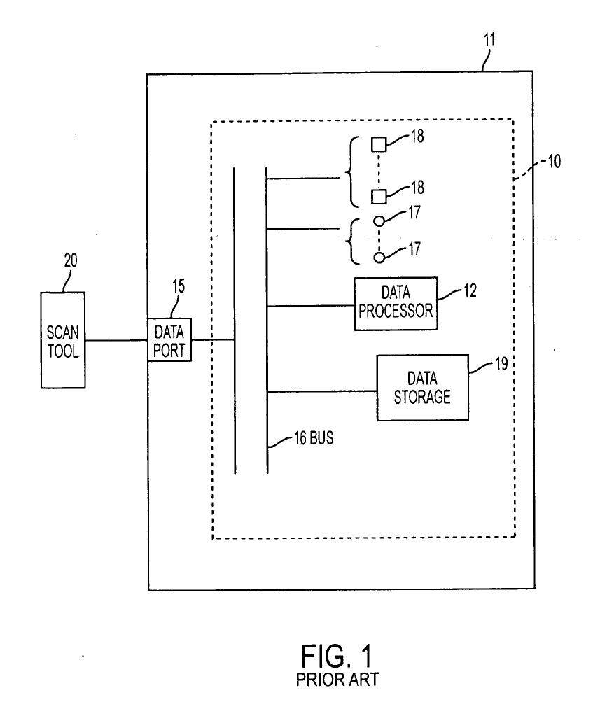

FIG. 1 shows an on-board diagnostic system 10 for use with a vehicle 11. Sensors 17 and electronic control units (ECUs) 18 are disposed at various portions of vehicle 11 to control the operations, and collect operation data, of various subsystems or parts of the vehicle, such as engine, transmission, tires, electronic system, AC, oil level, emission, etc. Diagnostic system 10 further includes a data processor 12 and a data storage device 19 for storing data. Examples of data storage device 19 include floppy disks, hard disk drives, magnetic tapes, optical disks, such as CD-ROM, DVD, semiconductor storage devices, such as RAM, PROM, and EPROM, FLASH-EPROM, memory chips or cartridges, etc., or any combination(s) thereof. Data processor 12, data storage device 19, sensors 17 and ECUs 18 are coupled to a diagnostic bus 16. Data processor 12 performs diagnoses on various subsystems of vehicle 11 based on information provided by ECUs 18 and sensors 17, and records error codes in data storage device 19. Based on the performed diagnoses, data processor 12 generates diagnostic trouble codes (DTC) indicating conditions of the vehicle and stores any information that related to each DTC. A data port 15 is provided for coupling to an exemplary scan tool 20 according to this disclosure. Examples of data port 15 include OBD II interface, USB connectors, wireless transceivers, or any type of data outlet for transmitting data.

An exemplary scan tool according to this disclosure communicates with, or download data from, on-board diagnostic systems using a predetermined communication protocol, such as serial communication protocols (i.e CAN, SAE J1850, etc.), and reads and displays any diagnostic trouble codes (DTC) reported by the vehicle diagnostic system.

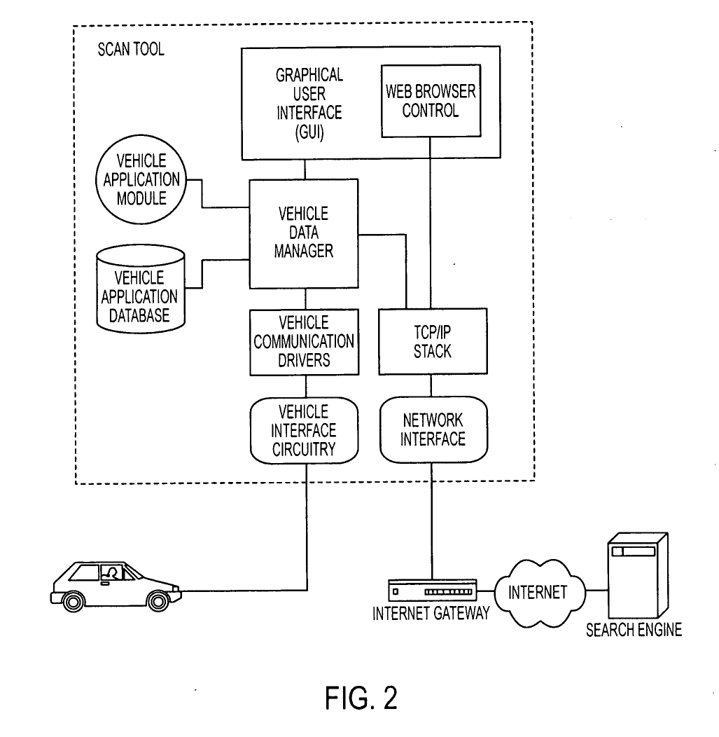

FIG. 2 shows a block diagram of an exemplary scan tool according to this disclosure. The exemplary scan tool includes a data port and vehicle interface circuitry for coupling to a vehicle on-board computer. Examples of the data port and the vehicle interface circuitry include OBD II interface, USB connectors, wireless transceivers, or any type of data outlet for transmitting data. Appropriate vehicle communication drivers are provided and stored in the scan tool for communicating with on-board computers on different vehicle models. The scan tool includes a network interface for linking to a data network, such as the internet or a private local area data network. The network interface may include TCP/IP stack for network connections and data transmissions. The scan tool also has access to search engines, such as Google, Yahoo Search, MSN, etc. The scan tool automatically formulates and generates appropriate search strings or queries targeting at retrieving relevant information on reported DTCs. The generated search strings or queries are submitted to the search engines to retrieve relevant information from multiple data sources. A web browser control is provided to display the search results.

The scan tool may be implemented on various platforms offering a graphical user interface, including, but not limited to a Windows PC, with internal or external vehicle interface, an embedded Windows CE platform with integrated or external vehicle interface, or a Pocket PC with external vehicle interface. The scan tool interfaces to the internet or a private network, using a network interface and TCP/IP protocol. The network interface can be realized using various physical interface types (i.e. Ethernet, 802.11 Wireless LAN, etc.). Search Results can be implemented with a browser application (i.e. Internet Explorer, Netscape, etc.) or using an embedded browser control or other software capable of rendering hypertext markup language (HTML) and its derivatives.

The exemplary scan tool utilizes a database-driven architecture for communicating with vehicles, retrieving vehicle data and assembling search queries. A vehicle application database is used to store all vehicle-controller-specific data, such as the format of query messages used to request parameters from on-board diagnostic systems (i.e. engine speed, coolant temperature, etc.) or to request DTCs; the format of the response messages expected from the vehicle; conversion formulas for parameters; etc. The vehicle application database further includes the Uniform Resource Locators (URL) and search string elements to be used in assembling search queries based on DTCs received from vehicle on-board computers.

In one embodiment, the scan tool includes a vehicle application module that stores procedures required for communicating with vehicle control modules or on-board diagnostic systems that may be too complex to be represented in the vehicle application database, such as interactive or time-dependent sequences. For example, an interactive test may involve a series of queries to, and responses from, an engine or brake system, including conditional logic. In another example, the vehicle manufacturer may require that a security password be entered, prior to accessing certain diagnostic functions. This interaction between the user and the vehicle would be controlled by execution of the code stored in the vehicle application module.

The scan tool further includes a vehicle data manager containing all software routines that are common to all vehicle diagnostic applications, irrespective of vehicle communication protocols. The function performed by the software routines stored in the vehicle data manager include the ability to compose a message (such as via database lookup or search), send the message to the vehicle, receive a message from the vehicle, timestamp and log the message, interpret the message (such as by database lookup or search), present received data or DTC's to the user, generate a search string (such as by database lookup or search), and send it to the internet.

More details of the hardware architecture of the scan tool are discussed below. The scan tool includes a bus or other communication mechanism for communicating information, and a data processor coupled to the bus for processing data. The scan tool also includes a main memory, such as a random access memory (RAM) or other dynamic storage device, coupled to the bus for storing information and instructions to be executed by the processor. The main memory also may be used for storing temporary variables or other intermediate information during execution of instructions to be executed by the data processor. The scan tool further includes a read only memory (ROM) or other static storage device coupled to the bus for storing static information and instructions for the processor. A storage device, such as a magnetic disk or optical disk, is provided and coupled to the bus for storing information and instructions. The instructions, upon execution by the data processor, control the scan tool to perform the functions and/or steps described in this disclosure.

The scan tool may include a user interface, such as a play like a cathode ray tube (CRT) or liquid crystal display (LCD), for displaying information to an operator. An input device, including alphanumeric and other keys, is coupled to the bus for communicating information and command selections to the processor. Another type of user input device is a cursor control, such as a mouse, a trackball, or cursor direction keys and the like for communicating direction information and command selections to the processor and for controlling cursor movement on the display.

The scan tool is controlled in response to the processor executing one or more sequences of one or more instructions contained in the main memory. Such instructions may be read into the main memory from another machine-readable medium, such as a storage device. Execution of the sequences of instructions contained in the main memory causes the processor to perform steps specified by the instructions. In alternative embodiments, hard-wired circuitry may be used in place of or in combination with software instructions to implement the disclosure. Thus, embodiments of the disclosure are not limited to any specific combination of hardware circuitry and software.

The term “machine readable medium” as used herein refers to any medium that participates in providing instructions to the processor for execution. Such a medium may take many forms, including but not limited to, non-volatile media, volatile media, and transmission media. Non-volatile media includes, for example, optical or magnetic disks, such as a storage device. Volatile media includes dynamic memory, such as the main memory. Transmission media includes coaxial cables, copper wire and fiber optics, including the wires that comprise the bus. Transmission media can also take the form of acoustic or light waves, such as those generated during radio wave and infrared data communications.

Common forms of machine readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a scan tool can read.

Various forms of machine-readable media may be involved in carrying one or more sequences of one or more instructions to the processor for execution. For example, the instructions may initially be carried on a magnetic disk of a remote scan tool, such as a server. The remote scan tool can load the instructions into its dynamic memory and send the instructions over a telephone line using a modem. A modem local to the scan tool can receive the data on the telephone line and use an infrared transmitter to convert the data to an infrared signal. An infrared detector can receive the data carried in the infrared signal and appropriate circuitry can place the data on the bus. The bus carries the data to the main memory, from which the processor retrieves and executes the instructions. The instructions received by the main memory may optionally be stored on the storage device either before or after execution by the processor.

The exemplary scan tool also includes a communication interface coupled to the bus. The communication interface provides a two-way data communication coupling to a network link through one or more networks to other data devices.

### System Operation

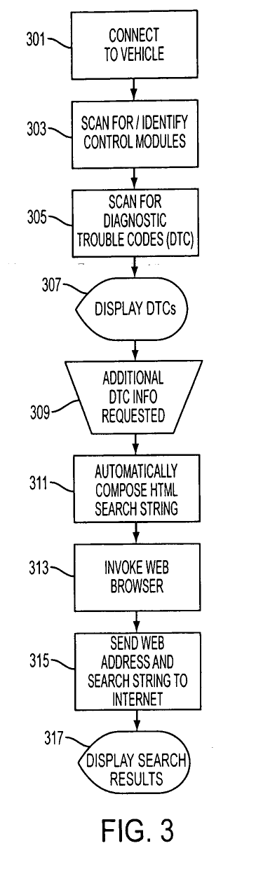

FIG. 3 is a flow chart illustrating the operation of the exemplary scan tool. In Step 301, the scan tool connects to the on-board diagnostic system. In Step 303, the scan tool sends a command requesting DTCs and/or diagnostic information from the on-board diagnostic system. In one embodiment, the command may request DTCs and/or diagnostic information from all ECUs or only those ECUs of interest. In Step 305, the requested DTCs and/or diagnostic information are downloaded from the on-board diagnostic system to the scan tool. The DTCs and/or diagnostic information are presented to a user for review, such as on a display, in Step 307. If needed, the scan tool may request additional DTCs and/or diagnostic information (Step 309). In one embodiment, as shown in Step 311, the scan tool automatically formulates and generates a search query or strings using the obtained DTCs, information related to the vehicle under test, and/or any pre-stored information. In Steps 313 and 315, the scan tool utilizes suitable application software, such as web browsers, to submit the search queries to multiple pre-selected data sources, such as search engines, web sites, and/or databases like Google, MSN, Yahoo!, Wikipedia, Answers.com, etc., that are coupled to the scan tool via the internet. The scan tool maintains a list of pre-selected data sources. The list of the data sources may be dynamically updated or modified by users or software updates. In Step 317, the search result returned by the multiple data sources, such as search engines, are made available to the user. In one instance, the search results are automatically presented to the user using a web browser.

In another embodiment, the user may select one or more DTCs and request additional information related to the selected DTCs. In response to the selection and the request, the scan tool formulates and generates a search query using the selected DTCs, and submits the search queries to selected search engines to conduct data search and retrieve information related to the selected DTCs.

The scan tool automatically generates a search query or a search string that complies with the requirements of different data sources or search engines. Different protocols or query formats for communicating with the data sources or search engines are stored in the vehicle application database. For instance, in generating a search query related to a reported diagnostic trouble code P1001 (P1001 is a manufacturer-specific DTC defined in accordance with Society of Automotive Engineers (SAE) standard J2012 Recommended Practice for Diagnostic Trouble Code Definitions), the scan tool will generate a web address http://www. google.com/search?q=DTC+P1001+Description, which includes a predetermined first address portion including “http://www.google.com/search?q=” and append to the first address portion with the automatically-generated terms “DTC+P1001+Description.” This is equivalent to entering “DTC P1001 Description” in the search box on Google.com. In this example, in addition to the received DTC, the scan tool also added two search terms “DTC” and “Description” in the generated search query to assist retrieving information related to the DTC. In some embodiments, information related to vehicle types, operation parameters, vehicle models, etc., is also incorporated into the query or search terms by the scan tool. Similarly, the scan tool formulates search terms complying with specific protocols for different search engines or websites by accessing information stored in the scan tool.

In one embodiment, the scan tool stores additional terms to be used with each DTC in the vehicle application database. For instance, information related to car maker and vehicle model and year can be added to search query.

In another embodiment, a scan tool according to this disclosure selects specific search engines or data sources to perform search according to types of information to be searched. The scan tool may store one or more look-up tables identifying the types of data sources to be used for each type of information to be searched. For instance, an exemplary scan tool may use Google for searching information for DTCs related to engine problems, and MSN for searching information related to electronic systems. In another example, an exemplary scan tool may include a search targeting at a specific website or data source, such as by dynamically extracting pre-specified or pre-defined data from the diagnostic information downloaded from the vehicle or any information related to the vehicle under test. The predefined data may be a vehicle model or a vehicle maker. For instance, if a vehicle under test is a Ford Taurus, the scan tool will request a search on Ford's website, such as www.ford.com or www. Taurus.com, using the generated query.

The disclosure has been described with reference to specific embodiments thereof. It will, however, be evident that various modifications and changes may be made thereto without departing from the broader spirit and scope of the disclosure. The concepts described in the disclosure can apply to various operations of the networked presentation system without departing from the concepts. The specification and drawings are, accordingly, to be regarded in an illustrative rather than a restrictive sense.

What is claimed is:

1. A scan tool external to a vehicle, comprising:
a data processor configured to process data;
a data port configured to couple to, and receive diagnostic information from, an on-board computer of the vehicle;
a network interface configured to couple to a data transmission network; and
a data storage device storing instructions that, upon execution by the data processor, control the diagnostic device to:
generate a search query according to the received diagnostic information;
access pre-stored information identifying multiple data sources;
using the search query, initiate a data search on the multiple data sources for information related to the received diagnostic information, wherein the multiple data sources couple to the scan tool via the data transmission network;
receive a result of data search returned by the multiple data sources; and
present the result of data search via a user interface.

2. The scan tool of claim 1, wherein the diagnostic information includes diagnostic trouble codes.

3. The scan tool of claim 1, wherein the data port is a wireless communication port or a OBD-II compatible port.

4. The scan tool of claim 1, wherein the stored instructions, upon execution by the data processor, further control the diagnostic device to:
extract pre-defined data from the received diagnostic information or information related to the vehicle;
according to the extracted data, identify a data source coupled to the scan tool via the data transmission network;
using the search query, initiate a data search on the identified data source for information related to the received diagnostic information; and
receive a result of data search returned by the identified data source.

5. The scan tool of claim 4, wherein the pre-defined data is a model or a maker of the vehicle.

6. The scan tool of claim 1, wherein the data storage device stores information identifying multiple types of information to be searched, and at lest one data source corresponding to each type of information on which a data search should be conducted.

7. The scan tool of claim 6, wherein different data sources are used for searching different types of information.

8. A scan tool external to a vehicle, comprising:
data processing means for processing data;
a data port for coupling to, and receiving diagnostic information from, an on-board computer of the vehicle;
network interface means for coupling to a data transmission network; and
data storage means for storing instructions that, upon execution by the data processor, control the diagnostic device to:
generate a search query according to the received diagnostic information;
access pre-stored information identifying multiple data sources;
using the search query, initiate a data search on the multiple data sources for information related to the received diagnostic information, wherein the multiple data sources couple to the scan tool via the data transmission network;
receive a result of data search returned by the multiple data sources; and
present the result of data search via a user interface.

9. The scan tool of claim 8, wherein the diagnostic information includes diagnostic trouble codes.

10. The scan tool of claim 8, wherein the stored instructions, upon execution by the data processor, further control the diagnostic device to:
extract pre-defined data from the received diagnostic information or information related to the vehicle;
according to the extracted data, identify a data source coupled to the scan tool via the data transmission network;
using the search query, initiate a data search on the identified data source for information related to the received diagnostic information; and
receive a result of data search returned by the identified data source.

11. The scan tool of claim 10, wherein the pre-defined data is a model or a maker of the vehicle.

12. The scan tool of claim 8, wherein the data storage device stores information identifying multiple types of information to be searched, and at lest one data source corresponding to each type of information on which a data search should be conducted.

13. The scan tool of claim 12, wherein different data sources are used for searching different types of information.

14. A vehicle diagnostic method comprising the steps performed by a scan tool external to a vehicle, the step comprising:
receiving diagnostic information from an on-board computer of the vehicle;
generating a search query according to the received diagnostic information;
accessing pre-stored information identifying multiple data sources;
using the search query, initiating a data search on the multiple data sources for information related to the received diagnostic information, wherein the multiple data sources couple to the scan tool via a data transmission;
receiving a result of data search returned by the multiple data sources coupled to the scan tool via the data transmission network; and
presenting the result of data search via a user interface.

15. The method of claim 14 further comprising the steps of:
extracting pre-defined data from the received diagnostic information or information related to the vehicle;
according to the extracted data, identify a data source coupled to the scan tool via the data transmission network;
using the search query, initiate a data search on the identified data source for information related to the received diagnostic information; and
receive a result of data search returned by the identified data source.

16. The scan tool of claim 15, wherein the pre-defined data is a model or a maker of the vehicle.

17. The scan tool of claim 14 further comprising the step of storing information in the scan tool identifying multiple types of information to be searched, and at lest one data source corresponding to each type of information on which a data search should be conducted.

18. The scan tool of claim 17, wherein different data sources are used for searching different types of information.

19. A machine-readable medium bearing instructions which, upon execution by a scan tool external to a vehicle, controls the scan tool to:
receive diagnostic information from a vehicle on-board computer on the vehicle;
generate a search query according to the received diagnostic information;
access pre-stored information identifying multiple data sources coupling to the scan tool via a data transmission network;
using the search query, initiate a data search on the multiple data sources for information related to the received diagnostic information, wherein the multiple data sources couple to the scan tool via the data transmission network;
receive a result of data search returned by the multiple data sources; and
present the result of data search via a user interface.
